(19) United States
(12) Patent Application Publication
(10) Pub. No.: US 2025/0199730 A1
(43) Pub. Date: Jun. 19, 2025

(54) PRINTING APPARATUS, METHOD OF CONTROLLING PRINTING APPARATUS, AND STORAGE MEDIUM

(71) Applicant: CANON KABUSHIKI KAISHA, Tokyo (JP)

(72) Inventor: IZUMI FUJIWARA, Tokyo (JP)

(21) Appl. No.: 18/936,753

(22) Filed: Nov. 4, 2024

(30) Foreign Application Priority Data
Dec. 19, 2023 (JP) 2023-213716

(51) Int. Cl. G06F 3/12

(52) U.S. Cl. CPC G06F 3/1229; G06F 3/121; G06F 3/1289

(57) ABSTRACT

A printing apparatus receiving power supplied from a wired interface terminal or power from a power storage unit, the printing apparatus including a memory storing a program and a processor, that when executing the program, causes the printing apparatus to check a charge level of the power storage unit and transition to a power state in which a function is limited based on the charge level and whether the printing apparatus is in a supply state in which power is supplied from the wired interface terminal.

### BACKGROUND

### Field

The present disclosure relates to a printing apparatus, a method of controlling a printing apparatus, and a storage medium.

### Description of the Related Art

There are printing apparatuses that are portable and compact. Such compact apparatuses have, as a power supply, an internal battery rechargeable by receiving power from a wired interface terminal and are applicable for outdoor use.

Various suggestions have been conventionally made for control of an inkjet recording apparatus that has an internal battery and operates on power received from a wired interface terminal.

For example, Japanese Patent Laid-Open No. 2015-152846 discloses that a printing apparatus transitions to a low-power state (power consumption saving state) based on whether power is supplied from an external device via a USB cable.

In Japanese Patent Laid-Open No. 2015-152846, even in a case where the functions of the printing apparatus can be continued, there is a possibility that the printing apparatus transitions to the low-power state and the functions of the printing apparatus are restrained due to absence of power supply from the USB cable. In a case where a charge level of the internal battery is low, there is a possibility that the printing apparatus is shut down by consumption of power necessary for transition to the low-power state.

### SUMMARY

A printing apparatus according to an aspect of the present disclosure receives power from a wired interface terminal or power from a power storage unit, the printing apparatus including a memory storing a program and a processor, that when executing the program, causes the printing apparatus to check a charge level of the power storage unit, and transition to a power state in which a function is limited based on the charge level and whether the printing apparatus is in a supply state in which power is supplied from the wired interface terminal.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a printing system.

FIG. 2 is a block diagram a configuration of a control system of a printer.

FIG. 3 is a block diagram illustrating a configuration of a power supply system of the printer.

FIG. 4 is a table illustrating power supply levels of respective connection standards.

FIG. 5 is a table illustrating a relationship between operation types of the printer and the connection standards.

FIG. 6 is a flowchart illustrating processing contents of a CPU of the printer.

FIG. 7 is a state transition diagram of a power state of the printer.

FIG. 8 is a table illustrating a relationship between available functions and a charge level necessary for transition for each power state.

FIG. 9 is a flowchart illustrating processing contents of transition to a low-power state.

FIG. 10 is a flowchart illustrating processing contents of transition to a power-off state.

### DESCRIPTION OF THE EMBODIMENTS

Embodiments of the present disclosure will be described below. The constituent elements described in the embodiments are only provided as examples of the present disclosure and the scope of the present disclosure is not limited to them.

### First Embodiment

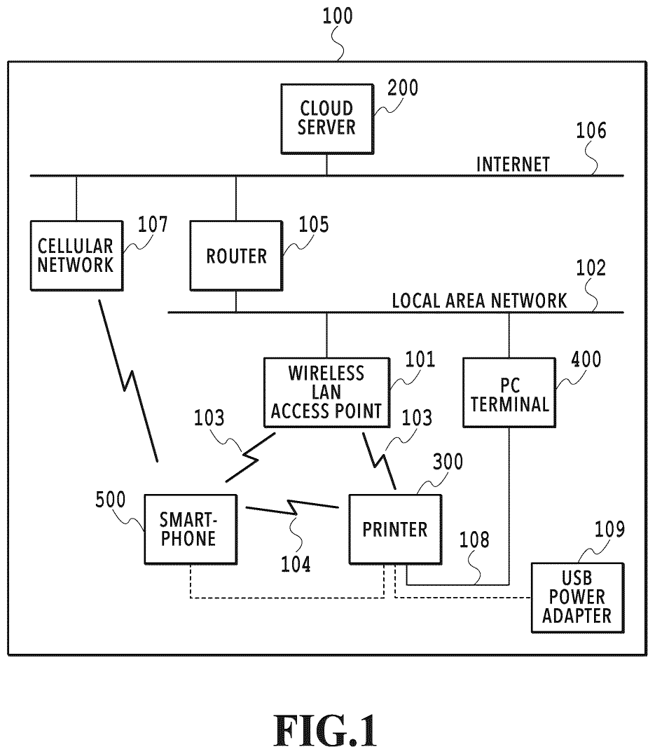

FIG. 1 is a diagram illustrating a configuration of a system 100 according to the present embodiment. The system comprises a printer 300 and a smartphone 500 that are connected via a local area network 102. Both the printer 300 and the smartphone 500 are wirelessly connected to a wireless LAN access point 101 and thereby connected to the local area network 102. Wireless LAN infrastructure mode connection 103 is used between the printer 300 and smartphone 500 and the wireless LAN access point 101.

The printer 300 has a mode in which the printer 300 functions as a wireless LAN access point by itself. While the printer 300 functions as an access point, the smartphone 500 can be directly connected to the printer 300 access point. This is defined as direct connection 104. The local area network 102 can be connected to other terminals such as a personal computer (PC) terminal 400. The local area network 102 is also connected to the Internet 106 via a router 105. The printer 300, the smartphone 500, and other devices can communicate with a cloud server 200 on the Internet 106 via the router 105. The smartphone 500 is also connected to a cellular network 107.

The smartphone 500 can also be connected to the cloud server 200 on the Internet 106 via the cellular network 107. The printer 300 comprises a USB connection terminal to enable USB connection with various devices. FIG. 1 illustrates a case where the printer 300 is connected to and powered by the PC terminal 400 via a USB cable 108. As illustrated by a dashed line, the printer 300 can also be connected to and powered by the smartphone 500 via the USB cable 108. The printer 300 can also be connected to and powered by a USB power adapter 109. Power can be supplied from a mobile battery via the USB cable 108. In a case where the printer 300 is connected to the PC terminal 400 or smartphone 500 via the USB cable 108, data communication between the terminal device and the printer 300 can use the USB, but is not limited to this. A wireless LAN or near-field communication can be used for data communication while power is supplied from the PC terminal 400 or smartphone 500 connected via the USB cable 108.

The above description illustrates an example of the present embodiment, and any advantageous results of the present embodiment are not changed even in the case of a different configuration than the above-described configuration. For example, while the wireless LAN access point 101 and the router 105 are illustrated as different devices in the present embodiment, in another embodiment they can be configured as a single router device having an access point function.

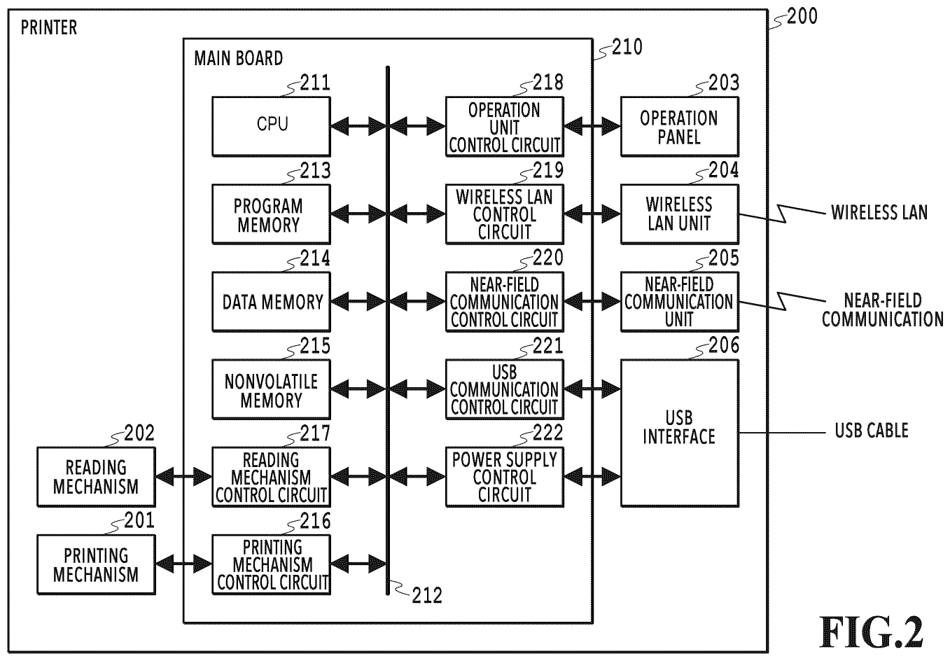

FIG. 2 is a block diagram illustrating a configuration of a control system of the printer 300. The printer 300 comprises various units such as a main board 210 that controls the entire apparatus, a wireless LAN unit 204, and a near-field communication unit 205. A CPU 211 in microprocessor form arranged on the main board 210 operates according to a control program stored in a program memory 213 in ROM form connected via an internal bus 212 and a content of a data memory 214 in RAM form. There is also provided a nonvolatile memory 215 that can store contents even without power supply. The CPU 211 writes various set values or data to the nonvolatile memory 215. Accordingly, in a case where power is temporarily turned off and then turned on again, the operation can be continued based on the same set values or data. An example of the nonvolatile memory 215 is a semiconductor storage device such as a flash memory. The flash memory can maintain stored contents even during non-energization, but often has a limit to the number of times of rewriting for each memory element. Thus, it is necessary to make a design in consideration of the timings of writing to the nonvolatile memory in the life of the device. It is generally assumed that a storage device ensuring a larger number of times of rewriting would cost more per component.

The CPU 211 can control a reading mechanism 202 via a reading mechanism control circuit 217 to read a document and store it as image data information in the data memory 214. The CPU 211 can also control a printing mechanism 201 via a printing mechanism control circuit 216 to print image data in the data memory 214 on a print medium. The CPU 211 controls the wireless LAN unit 204 via a wireless LAN control circuit 219, and thereby, performs wireless LAN communication with other communication terminal devices. The CPU 211 can also control the near-field communication unit 205 via a near-field communication control circuit 220 to detect connection with other near-field communication terminals and transmit/receive data to/from other near-field communication terminals. The CPU 211 can control an operation unit control circuit 218 to display the state of the printer 300 or a function selection menu on an operation panel 203 or receive a user operation. The CPU 211 can operate a USB interface 206 via a USB communication control circuit 221 to perform USB communication with other terminal devices connected via the USB cable 108. The CPU 211 can control a power supply control circuit 222 to control a level of power supply from the USB interface 206 and a level of power stored in the power supply control circuit.

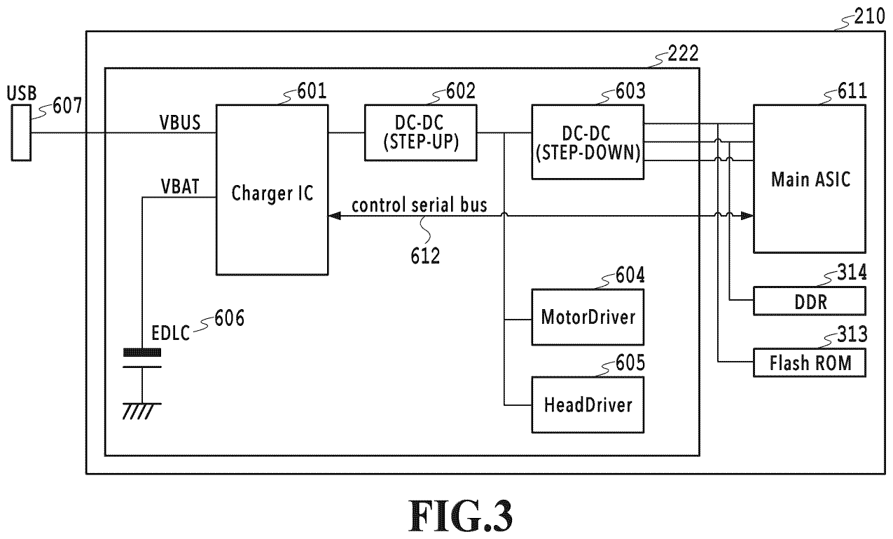

FIG. 3 is a block diagram illustrating a configuration of a power supply system of the printer 300. The printer 300 can be driven by inputting power supply V_{BAT} from an electric double layer capacitor (EDLC) 606, which is a power storage unit, to a Charger IC 601. Power supply to a printer electric system in the printer 300 is controlled by a power supply system by way of the Charger IC 601. The Charger IC 601 charges the EDLC 606 by a current provided by power supply V_{BUS} from a USB 607. At the same time, the Charger IC 601 produces output from the EDLC 606 to DC-DC (step-up) 602. The Charger IC 601 and the EDLC 606 are described below. The DC-DC (step-up) 602 is a step-up circuit to increase the voltage from the Charger IC 601. The increased voltage is used by a MotorDriver 604 to drive motors of the reading mechanism and printing mechanism, and also used by a HeadDriver 605 as driving power supply for a head, that is, takes charge of driving with a relatively-large load. The increased power supply is connected to a DC-DC (step-down) 603 circuit to produce a logic power supply voltage for use in an ASIC 611, Flash ROM 313, or DDR 314. The ASIC 611 is a custom IC including the CPU 211 and peripheral circuits. The Charger IC 601 is an IC having the function for input current control of the USB 607, charging control of the EDLC 606, or abnormal operation protection. The Charger IC 601 communicates with the ASIC 611 via a control serial bus 612. The control serial bus 612 is a part of the internal bus 312. In the present embodiment, a universal asynchronous receiver-transmitter (UART) system is used for communication. The Charger IC 601 determines an input current depending on a power source external device (PC terminal 400). In the present embodiment, determination is made based on a determination conforming to the USB Battery Charge (USB-BC) standard (hereinafter referred to as a BC determination) and a determination conforming to the USB Power Delivery (USB-PD) standard (hereinafter referred to as a CC determination). Upon receipt of the results of BC and CC determinations from the Charger IC 601, the ASIC 611 determines thresholds of a charging current, full charge, and over discharge voltage of the Charger IC 601, and sets the thresholds in the Charger IC 601. The EDLC 606 is an electric double layer capacitor and controls charging from the Charger IC 601 under instructions from the ASIC 611. The EDLC 606 also powers the DC-DC (step-up) 602, the MotorDriver 604, and the HeadDriver 605 by power supply V_{BAT}. The power supply V_{BAT} voltage of the EDLC 606 can be sent from the Charger IC 601 to the ASIC 611. Various types of information about power supply can be sent from the Charger IC 601 to the ASIC 611. The information can be used for various kinds of control of the printer 300. For example, in a case where the power supply V_{BAT} voltage of the EDLC 606 decreases in a printing operation of the printer 300, the ASIC 611 stops the printing operation and instructs the Charger IC 601 to perform charging control until the power supply V_{BAT} voltage of the EDLC 606 reaches a predetermined threshold. Upon receipt of information that the power supply V_{BAT} voltage reaches the threshold, the ASIC 611 can perform control to resume the printing operation. In a case where power is fed from the USB 607, if the cable of the USB 607 is removed or power feeding from the USB 607 is stopped during the operation, an operation for stopping power feeding can be immediately started. This operation can be started by sending a notification from the Charger IC 601 to the ASIC 611.

The ASIC 611 can also obtain information on a charge level of the EDLC 606 from the Charger IC 601 and perform control according to the charge level. For example, in a case where the cable of the USB 607 is removed and power supply V_{BAT} from the EDLC 606 is used for driving, if the charge level of the EDLC 606 decreases to a predetermined threshold, the ASIC 611 can immediately start an operation corresponding to the low charge level state.

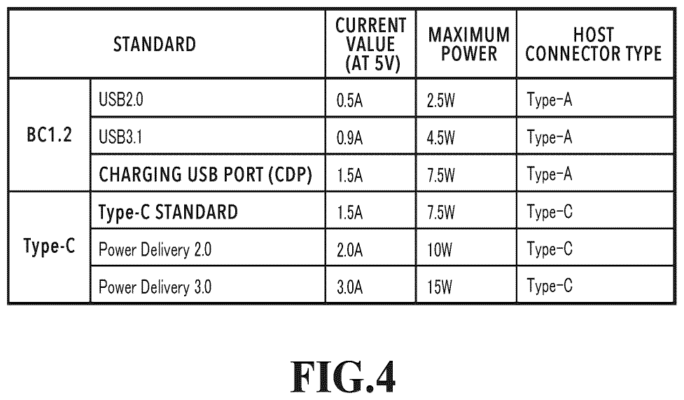

FIG. 4 is a table illustrating power supply levels of respective connection standards. BC1.2 is the USB-BC (Battery Charge) standard defining a method of electrically identifying a charging USB port (CDP) using D+ and D− signal lines for USB data communication. In the case of a standard USB port that is not a charging port, communication based on the USB standard is performed after the above detection and the USB version can be discriminated in the communication. USB Type-C defines the Power Delivery standard and can notify a power supply level by communication via CC pins. While the supply power voltage can be controlled between 5 and 48V in the Power Delivery standard, FIG. 4 illustrates the maximum power as a value at 5V supply.

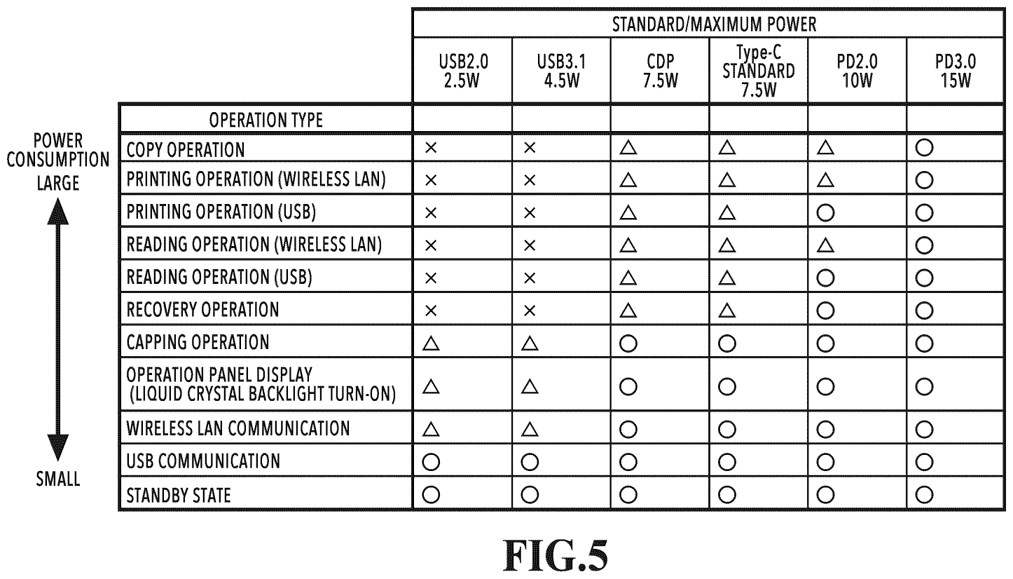

FIG. 5 illustrates a decision table for deciding whether to change connection. The possibility of execution is indicated by a combination of a type of operation to be executed on the vertical axis and a power supply standard on the horizontal axis. The contents of the decision table can be stored as table data in the program memory 213 or can be implemented as a program code. Examples of the operation types on the vertical axis include a copy operation, a printing operation, and a reading operation. A recovery operation is a maintenance operation for keeping good printing quality of the inkjet print head. This operation is, for example, a suction operation of a pump for removing clogging of an ink ejection nozzle or an ink ejection operation of a predetermined amount in a head cap. When executing the recovery operation, power is consumed to drive a motor for the suction operation of the pump or execute the ink ejection operation. A capping operation is a maintenance operation for protecting the inkjet print head against breakage or drying. By fixing a surface with ejection nozzles of the head by the cap, solidification or drying of the ink ejection nozzles can be prevented and the head can be fixed to a predetermined position to avoid movement and breakage of the head in the apparatus during conveyance of the printer 300. When executing the capping operation, power is consumed for motor driving to move the head to a cap position and push the cap against the ejection nozzle surface of the head. The amount of power consumption in the capping operation alone can be less than that in the recovery operation.

Operation panel display, wireless LAN communication, and USB communication are executed simultaneously with another operation, but consume power even without any other operation. The operation types on the vertical axis are listed in descending order of power consumption from top to bottom. In the decision table, “∘” indicates a combination of a power supply standard on the horizontal axis and an operation on the vertical axis in which power necessary for the operation is below the power supply capability and therefore the operation can be continuously executed. “Δ” indicates that power necessary for the operation is above the power supply capability and therefore the execution of the operation requires consumption of power charged in the EDLC 606. Such an operation cannot be continuously executed but can be conditionally executed by slowing down the speed to reduce the power consumption or being performed intermittently while having an interval for charging as appropriate. “x” indicates that the necessary power largely exceeds the power supply capability and the operation cannot be conditionally executed even as the speed cannot be reduced or an interval for charging cannot be placed during the operation.

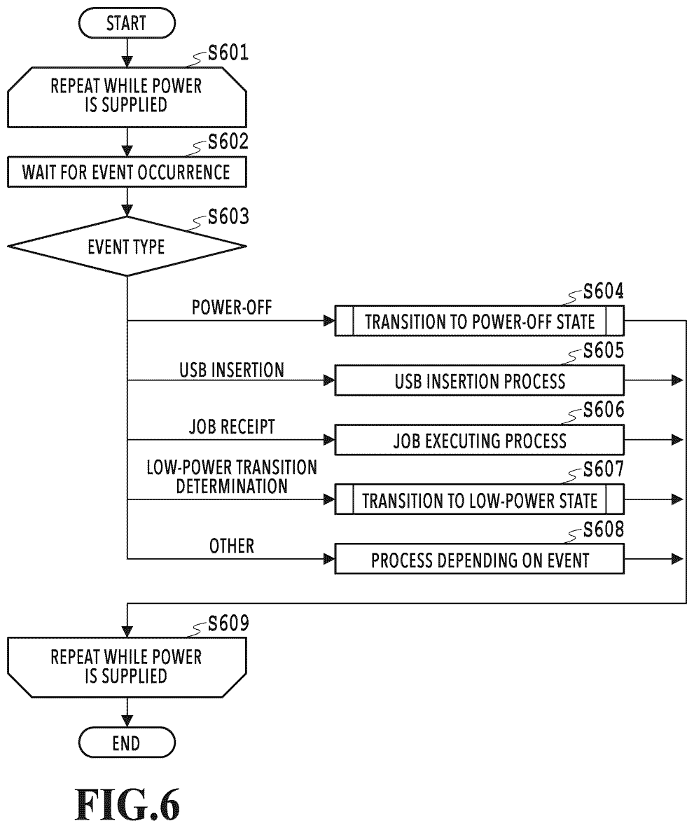

FIG. 6 is a flowchart illustrating processing contents of the CPU 211 of the printer 300. FIG. 6 is a main routine executed by the CPU 211 of the printer 300. This process is executed by the CPU 211 of the printer 300 by logic power supply to the ASIC 611 and execution of a power-on operation. The series of processes illustrated in the flowchart is executed by the CPU 211 of the printer 300 loading a program code stored in the program memory 213 into the data memory 214 and executing the program code. In the description of each process, “S” indicates a step in the flowchart.

In the process of the flowchart of FIG. 6, a loop from S601 to S609 is repeatedly executed until the printer 300 transitions to a power-off state or an AC-off state or the logic power supply to the ASIC 611 is shut off. During the loop, in S602, the CPU 211 waits for occurrence of an event to be processed. In S603, the CPU 211 determines a type of an event that has occurred. Then, a process depending on the determined type, or an event-drive process, is executed.

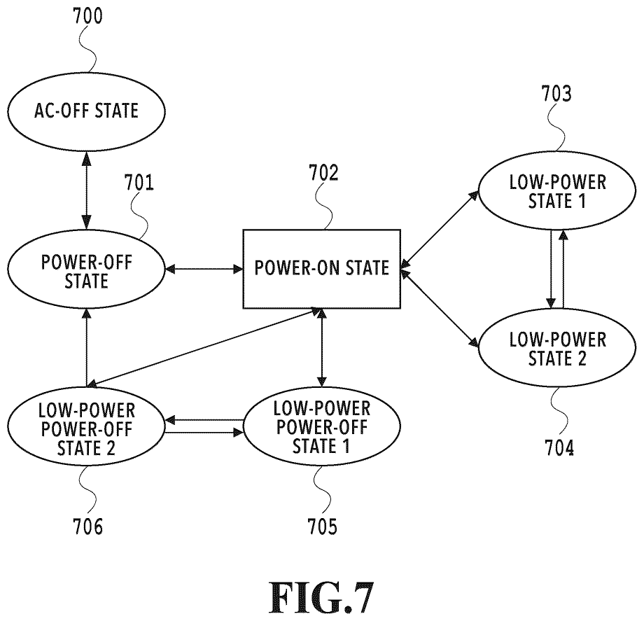

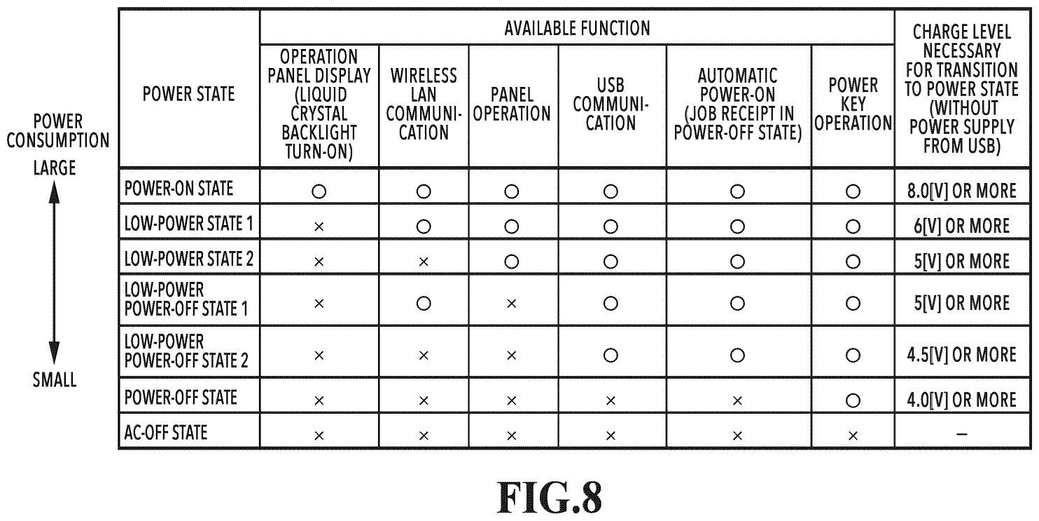

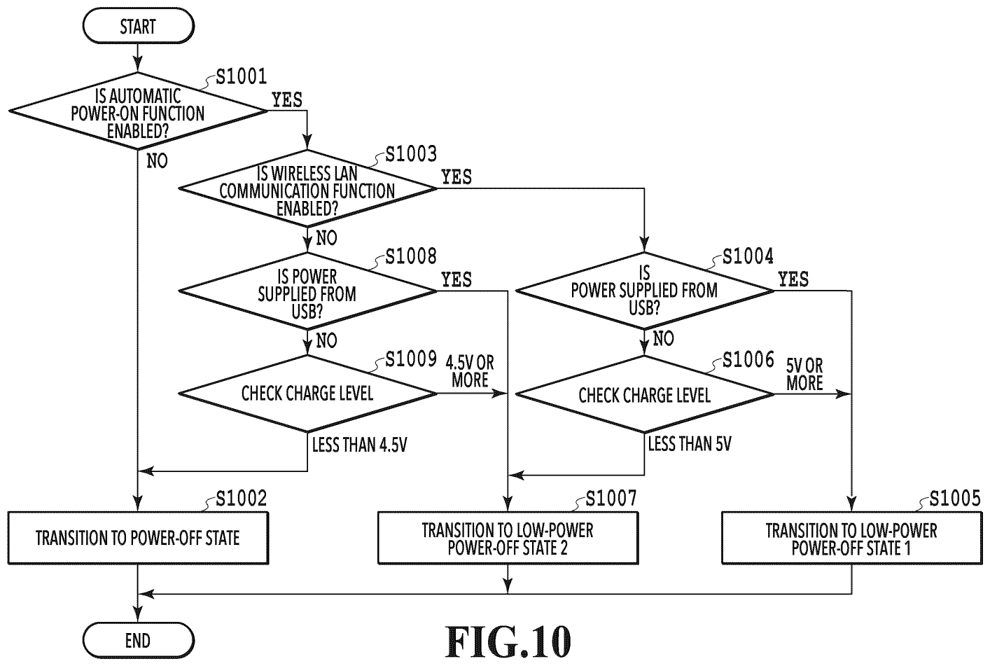

In a case where the event determined in S603 is detection of a power-off operation, the process proceeds to S604 and the CPU 211 transitions the power state to any power-off state. In the present embodiment, the power-off state indicates power states illustrated in FIG. 7, such as a power-off state (701), a low-power power-off state 1 (705), or a low-power power-off state 2 (706). By entering any of the power-off states, the CPU 211 exits from the loop and finishes the processing of the flowchart. The process of transition to the power-off state is described below with reference to FIG. 10. Since power is consumed by transition to a power state, a charge level necessary for transition to each power state is determined. This process is described below with reference to FIG. 8. At this point in the process, in a case where the charge level is insufficient for transition to any of the above-described power-off states, the process can proceed directly to S609.

In a case where the event determined in S603 is detection of insertion of the USB cable 108, the process proceeds to S605 and the CPU 211 executes a USB insertion process after the USB insertion. More specifically, the CPU 211, based on results of BC and CC determinations detected by the power supply control circuit, obtains a type of USB power feeding and a current value and executes a communication connection establishing process.

In a case where the event determined in S603 is receipt of a job from the PC terminal 400 or smartphone 500 via the USB or wireless LAN, the process proceeds to S606 and the CPU 211 executes a job executing process. The process in execution of a job is determined by a content notified by the job and a print job, a scan job, or any other process is executed as appropriate. In a case where the charge level of the EDLC 606 is insufficient for execution of the corresponding job, the execution of the job can be stopped and a time necessary for starting execution of the job can be displayed on the operation panel 203. In a case where the charge level becomes sufficient for execution, the execution of the job is resumed. The content displayed on the operation panel 203 can be a progress illustrated as percentages or as a progress bar.

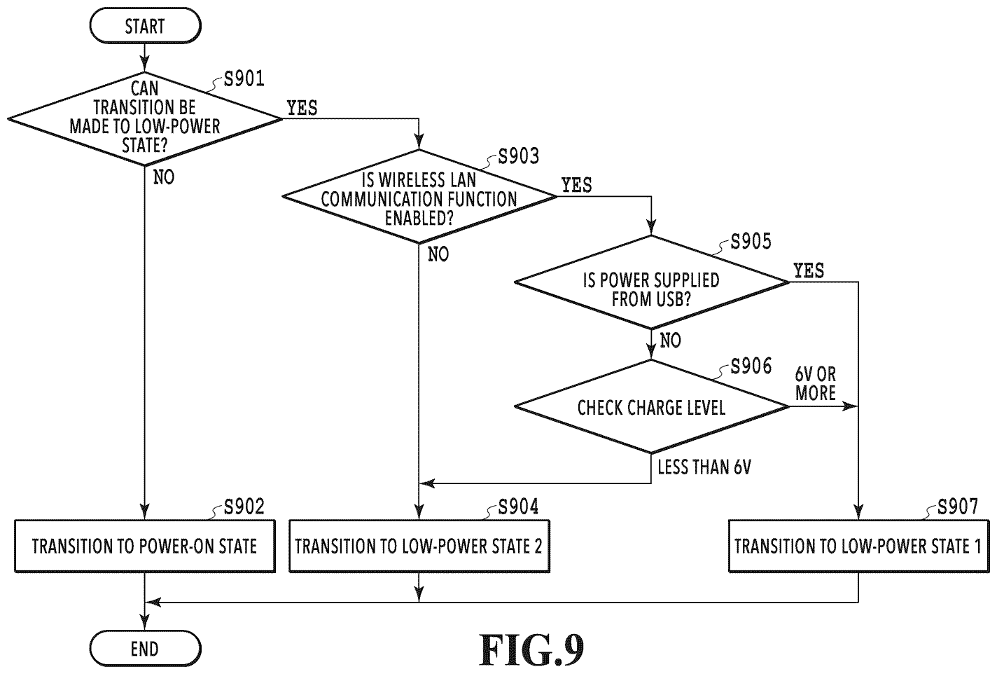

In a case where the event determined in S603 is a low-power transition determination, the process proceeds to S607 and the CPU 211 performs control for transition to a low-power state. The content of the process of control for transition to the low-power state will be described below with reference to FIG. 9. The low-power transition determination event can be periodically executed or instructed by the Charger IC 601. In the stage of the process, in a case where the charge level is insufficient for transition to any low-power state, the process can skip directly to S609.

In a case where the event determined in S603 is an event other than any of the above-described events, then in step S608, the CPU 211 executes a process based on the event that has occurred. For example, in a case where an event notification that the USB is connected but the charge level is insufficient is received, the operation panel 203 can display a screen illustrating that the printer is on charge until the minimum necessary power is charged. The information displayed on the operation panel 203 can be a two-dimensional code, where a user can read the two-dimensional code with the smartphone 500 to obtain information about the printer. In the case of an event notification that power is turned on for the first time, the operation panel 203 can display an operation or information specific to the first power-on. In a case where the above event notification is received, if a dedicated application is installed in the USB connection destination, the application can be activated and information about the printer can be displayed on an operation panel of the USB connection destination. As described above, the printer 300 repeats S601 to 609 while power is supplied.

FIG. 7 illustrates a state transition diagram of the power state of the printer 300. In the present embodiment, the printer 300 transitions to the following seven power states: AC-off state (700), power-off state (701), power-on state (702), low-power state 1 (703), low-power state 2 (704), low-power power-off state 1 (705), and low-power power-off state 2 (706).

The printer 300 is in the AC-off state (700) in a case where neither the power supply V_{BAT} from the EDLC 606 or the power supply V_{BUS} from the USB 607 exist and the Charger IC 601 receives no power supply. In a case where power is supplied to the Charger IC 601 and the ASIC 611 receives logic power supply, the CPU 211 transitions the power state from the AC-off state (700) to the power-off state (701). In the power-off state (701), the clock rate of the CPU 211 is less than those in the other power supply states and the operation panel 203 is powered off and does not accept operation except for a power key operation. The printing mechanism control circuit 216 or the reading mechanism control circuit 217 is powered off and the printing mechanism 201 and the reading mechanism 202 are inoperative. In a case where the operation of the power key included in the operation panel 203 is detected, the CPU 211 transitions the power state from the power-off state (701) to the power-on state (702). After the transition to the power-on state (702), the flowchart illustrated in FIG. 6 is executed, where the CPU 211 waits for occurrence of an event to be processed and executes a process based on the type of an event that has occurred. Based on the flowchart illustrated in FIG. 6, upon receipt of a low-power transition determination event, the CPU 211 executes control for transition to the low-power state in S607. The CPU 211, based on the process in S607, continues the power-on state (702) or transitions the power state to the low-power state 1 (703) or the low-power state 2 (704).

In the low-power state 1 (703) and the low-power state 2 (704), execution of the functions of the printer 300 is limited and power consumption is thus less than that in the power-on state (702). More specifically, in these states, the printing mechanism control circuit 216 or the reading mechanism control circuit 217 is powered off and the operations of the printing mechanism 201 and the reading mechanism 202 are limited. In the present embodiment, the low-power state 2 (704) limits the execution of more functions than the low-power state 1 (703), and therefore consumes less power. The functions executable in each power state will be described below with reference to FIG. 8.

In the power state of the low-power state 1 (703) or the low-power state 2 (704), in a case where an operation of the operation panel 203 or a job execution event is detected, the CPU 211 transitions to the power-on state (702). In the power-on state (702), the CPU 211 can execute all the functions of the printer 300. While the two low-power states are defined in the present embodiment, the number of states is not seen to be limited.

Based on the flowchart illustrated in FIG. 6, upon receipt of a power-off event, the CPU 211 executes control for transition to the power-off state in S604. The CPU 211, based on the process in S604, transitions the power state to the low-power power-off state 1 (705), the low-power power-off state 2 (706), or the power-off state (701). The low-power power-off state 1 (705) and the low-power power-off state 2 (706) are power-off states in which the functions of the printer 300 are partially enabled. Since the functions are partially enabled, the low-power power-off state 1 (705) and the low-power power-off state 2 (706) consume more power than the power-off state (701). Since the execution of the functions is limited, the low-power power-off state 1 (705) and the low-power power-off state 2 (706) consume less power than the low-power state 1 (703) and the low-power state 2 (704). The low-power power-off state 2 (706) limits the execution of more functions than the low-power power-off state 1 (705), and therefore consumes less power. In the low-power state 1 (703) and the low-power state 2 (704), in a case where an operation of the power key included in the operation panel 203 is detected or a job is received, transition to the power-on state (702) occurs, and all the functions of the printer 300 are enabled. While the three power-off states are defined in the present embodiment, the number of states is not seen to be limited.

FIG. 8 is a table illustrating the details of the power states of the printer 300. The vertical axis illustrates the power states and the horizontal axis illustrates available functions and charge levels of the EDLC 606 necessary for transition to the power states. The contents of FIG. 8 can be stored as table data in the program memory 213 or can be implemented as a program code.

In the illustrated table, power consumption of the power state increases from bottom to top. The horizontal axis illustrates six functions as an example of available functions. In the table, “∘” indicates a function executable in the corresponding power state. In contrast, in the table, “x” indicates a function not executable in the corresponding power state. For example, in the case of the power-on state (702), the CPU 211 of the printer 300 can execute all the functions illustrated as available functions in the table. Power consumption increases with the number of executable functions.

“Automatic power-on function” listed as an example of an available function is a function of receiving a job without a user's power-on operation in the power-off state. In this case, the job is received from an external device via the USB communication or wireless LAN communication. Upon receipt of the job, the printer 300 enters the power-on state (702). This automatic power-on function is enabled in the states other than the power-off state (701) or the AC-off state (700).

In the low-power power-off state 1 (705), the operation panel display and the panel operation are disabled, but the wireless LAN communication and the USB communication are enabled. Accordingly, the CPU 211 can receive a job from the PC terminal 400 or smartphone 500 via the USB or wireless LAN. Compared with the low-power power-off state 1 (705), since the wireless LAN communication is disabled in the low-power power-off state 2 (706), the CPU 211 can receive a job via the USB.

A function of enabling a user to enable or disable the wireless LAN communication function or the automatic power-on function can be provided. A user changes the setting by operating the operation panel 203 and the CPU 211 stores the set value in the nonvolatile memory 215. The CPU 211 then uses the set value stored in the nonvolatile memory 215 to execute control based on the set value. In the wireless LAN communication function, for example, output limitation can be imposed to weaken the communication strength in stages in addition to enablement/disablement.

The horizontal axis illustrates a charge level necessary for transition to each power state. In a case where power is not supplied from the USB and transition to the corresponding power state occurs, the CPU 211 determines whether the charge level of the EDLC 606 is greater than or equal to the charge level described in the table (greater than or equal to a threshold). In a case where the charge level of the EDLC 606 is less than that described/illustrated in the table (less than the threshold), if transition to the corresponding power state occurs, the ASIC 611 may not receive logic power supply early due to consumption of power charged in the EDLC 606, and the printer is shut down. In a case where the charge level of the EDLC 606 is less than that described/illustrated in the table, the CPU 211 does not transition to the corresponding power state and instead transitions to a power state with less power consumption.

While the six functions are defined as available functions in the present embodiment, the number of defined functions can be increased or reduced. While the voltage value is illustrated as a charge level necessary for transition to each power state in the present embodiment, different types of information, such as a power value, can be used and several types of information can be used in combination. The numerical value of each charge level is illustrated just as a rough standard, but can be changed as appropriate.

A description will now be provided of a method of transition to a suitable power state based on the presence/absence of power supply from an external device via the USB cable and the charge level of the EDLC 606. Transition to a suitable low-power state can reduce power consumption. The reduction of power consumption can reduce the possibility of a shutdown of the printing apparatus.

FIG. 9 is a flowchart illustrating the details of processing contents of transition to the low-power state in S607 of FIG. 6. In the process of the flowchart of FIG. 9, the CPU 211 performs control for transition to the power-on state (702), the low-power state 1 (703), or the low-power state 2 (704).

In S901, the CPU 211 determines whether transition can be made to the low-power state. In a case where the CPU 211 determines that transition can be made to the low-power state, the process proceeds to S903. In a case where the CPU 211 determines that transition cannot be made, the process proceeds to S902. More specifically, the CPU 211 determines whether a transition condition is satisfied. In the present embodiment, the transition condition is that “a job is not being executed,” “the operation panel 203 is not operated for a certain period of time and a liquid crystal backlight is turned off (backlight off),” or “the surface with ejection nozzles of the print head of the printing apparatus is fixed by the cap (cap close).” In a case where at least one of these conditions is satisfied, the CPU 211 determines that the answer in S901 is “yes”. The above-described conditions are only examples, and other conditions can be used. For example, the transition condition can be changed in stages depending on the charge level of the EDLC 606. More specifically, the CPU 211 can check the charge level necessary for transition to the power state with no power supply illustrated in FIG. 8 and, in a case where the CPU 211 determines that transition can be made to either the low-power state 1 or the low-power state 2, the process can proceed to S903.

In S902, the CPU 211 transitions the power state to the power-on state (702) and finishes the process. In a case where the power state is already the power-on state (702), the CPU 211 continues the power-on state (702) and the process then ends.

In S903, the CPU 211 determines whether the wireless LAN communication function of the printer 300 is enabled. As illustrated in FIG. 8, the wireless LAN communication function is enabled in the low-power state 1 (703) and disabled in the low-power state 2 (704). Thus, determining whether the wireless LAN communication function is enabled is equivalent to determining the low-power state to which transition can be made. In a case where the CPU 211 determines that the wireless LAN communication function is enabled, the process proceeds to S905. In a case where the CPU 211 determines that the wireless LAN communication function is disabled, the process proceeds to S904.

In S904, the CPU 211 transitions the power state to the low-power state 2 (704) and disables the enabled wireless LAN communication function. The process then ends.

In S905, the CPU 211 determines whether power is currently supplied from the USB (supply state). More specifically, the CPU 211 can check the USB connection state and the power supply level by checking the Charger IC 601 via the ASIC 611. In a case where the CPU 211 determines that power is supplied from the USB, the process proceeds to S907. In a case where the CPU 211 determines that power is not supplied from the USB, the process proceeds to S906.

In S906, the CPU 211 determines the charge level of the EDLC 606. More specifically, the CPU 211 can check the charge level of the EDLC 606 by checking the Charger IC 601 via the ASIC 611. The CPU 211 refers to the charge level necessary for transition to the power state, and in a case where the charge level is sufficient for transition to the low-power state 1 (703) (6V or more), the process proceeds to S907 and the CPU 211 transitions the power state to the low-power state 1 (703). The process then ends.

In S906, in a case where the CPU 211 determines that the charge level is insufficient for transition to the low-power state 1 (703) (less than 6V), the process proceeds to S904 and the CPU 211 transitions the power state to the low-power state 2 (704). The CPU 211 then disables the enabled wireless LAN communication function. That is, even in a case where the wireless LAN communication function is enabled in S903, if the charge level is insufficient for transition to the low-power state 1 (703) in S906, the CPU 211 disables the wireless LAN communication function and transitions to the low-power state 2 (704). The process then ends.

As described above, the flowchart of FIG. 6 is executed each time a low-power transition determination event is received in S603 while power is supplied. Thus, for example, after transition to the low-power state 1 (703), the process of the flowchart can be re-executed to transition to the low-power state 2 (704) or the power-on state. Thus, the power-on state, the low-power state 1 (703), and the low-power state 2 (704) can be switched from one to the other depending on the circumstances by repeatedly executing the process of the flowchart.

In S903, a user can in advance set whether the wireless LAN communication function is enabled or disabled. Even in a case where the setting is made to enable the wireless LAN communication function, the wireless LAN communication function can be disabled due to a communication failure or the like. In this case, transition is made to the low-power state 2 in which the wireless LAN function is disabled. Where the wireless LAN communication function is re-enabled upon recovery from a communication failure, transition can be made to the low-power state 1 via the processes of S905 and S906. Transition can be made to the low-power state 2 in a case where the wireless LAN communication function is disabled by a communication failure or the like after transition to the low-power state 1, and transition can be made to the low-power state 1 (703) immediately upon recovery from the communication failure. This also applies to the low-power power-off state described below.

FIG. 10 is a flowchart illustrating the details of the processing contents of transition to the power-off state in step S604 of FIG. 6. That is, this process is started in a case where execution of a power-off operation by a user is detected in S603. The CPU 211, via the process of the flowchart, performs control for transition to the power-off state (701), the low-power power-off state 1 (705), or the low-power power-off state 2 (706).

In S1001, the CPU 211 determines whether the automatic power-on function of the printer 300 is enabled. As illustrated in FIG. 8, the automatic power-on function is disabled in the power-off state (701) and enabled in the low-power power-off state 1 (705) and the low-power power-off state 2 (706). Thus, determining whether the automatic power-on function is enabled is equivalent to determining whether to transition to the power-off state (701). In a case where the CPU 211 determines that the automatic power-on function is disabled, the process proceeds to S1002. In a case where the CPU 211 determines that the automatic power-on function is enabled, the process proceeds to S1003.

In S1002, the CPU 211 transitions the power state to the power-off state (701). The process then ends. In a case where power is not supplied from the USB after transition to the power-off state (701), the Charger IC 601 continues consuming power of the EDLC 606. As a result, the Charger IC 601 cannot provide logic power supply to the ASIC 611 and the CPU 211 transitions the power state to the AC-off state (700).

In S1003, the CPU 211 determines whether the wireless LAN communication function of the printer 300 is enabled. As illustrated in FIG. 8, the wireless LAN communication function is enabled in the low-power power-off state 1 (705) and disabled in the low-power power-off state 2 (706). Thus, determining whether the wireless LAN communication function is enabled is equivalent to determining the low-power power-off state to which transition can be made. In a case where the wireless LAN communication function is enabled, the process proceeds to S1004. In a case where the wireless LAN communication function is disabled, the process proceeds to S1008.

In S1004, like S905 in FIG. 9, the CPU 211 determines whether power is currently supplied from the USB (whether in the supply state). In a case where the CPU 211 determines that power is supplied from the USB, the process proceeds to S1005 and CPU 211 transitions the power state to the low-power power-off state 1 (705). The process then ends. In a case where the CPU 211 determines that power is not supplied from the USB, the process proceeds to S1006.

In S1006, like S906 in FIG. 9, the CPU 211 determines the charge level of the EDLC 606. In a case where the CPU 211 determines that the charge level is sufficient for transition to the low-power power-off state 1 (705) (5V or more), the process proceeds to S1005. In a case where the CPU 211 determines that the charge level is insufficient for transition to the low-power power-off state 1 (705) (less than 5V), the process proceeds to S1007.

In S1007, the CPU 211 transitions the power state to the low-power power-off state 2 (706) and disables the enabled wireless LAN communication function. Even in a case where the CPU 211 determines that the wireless LAN communication function is enabled in S1003, if the charge level is insufficient for transition to the low-power power-off state 1 (705) in S1006, the CPU 211 disables the wireless LAN communication function and transitions to the low-power power-off state 2 (706). The process then ends.

Returning to the case where the CPU 211 determines in S1003 that the wireless LAN communication is disabled, in S1008, the CPU 211 determines whether power is currently supplied from the USB like in S1004. In a case where the CPU 211 determines that power is supplied from the USB, the process proceeds to S1007. In a case where the CPU 211 determines that power is not supplied from the USB, the process proceeds to S1009.

In S1009, the CPU 211 determines the charge level of the EDLC 606 like in S1006. In a case where the CPU 211 determines that the charge level is sufficient for transition to the low-power power-off state 2 (706) (4.5V or more), the process proceeds to S1007 and the CPU 211 transitions the power state to the low-power power-off state 2 (706). The process then ends. In a case where the CPU 211 determines that the charge level is insufficient for transition to the low-power power-off state 2 (706) (less than 4.5V), the process proceeds to S1002 and CPU 211 transitions the power state to the power-off state (701). The process then ends

As described above, according to the present embodiment, transition of the power state can be suitably made. More specifically, in a case where the power state is transitioned to the low-power state or the power-off state, both the power supply from the USB 607 and the charge level of the EDLC 606 are taken into consideration. As a result, power consumption can be reduced and an unintended shutdown of the printing apparatus can be prevented.

### Other Embodiments

The state transition diagram of the power state of the printer illustrated in FIG. 7 is just an example. Accordingly, for example, transition can be made directly from the low-power state to the low-power power-off state. In a case where a user operation is not detected for a certain period of time in the low-power state, power for displaying the operation panel can be saved by transition to the low-power power-off state 1. Since power is also necessary for transition from the low-power state to the low-power power-off state, it is preferable to suitably determine whether to make state transition based on the charge level and the benefit of transition of the power state.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-213716, filed Dec. 19, 2023, which is hereby incorporated by reference wherein in its entirety.

What is claimed is:

1. A printing apparatus receiving power supplied from a wired interface terminal or power from a power storage unit, the printing apparatus comprising:
a memory storing a program; and
a processor, that when executing the program, causes the printing apparatus to:
check a charge level of the power storage unit; and
transition to a power state in which a function of the printing apparatus is limited based on the charge level and whether the printing apparatus is in a supply state in which power is supplied from the wired interface terminal.

2. The printing apparatus according to claim 1, wherein in a case where the printing apparatus is in the supply state or the charge level is greater than or equal to a first threshold, the printing apparatus transition transitions to the power state in which a wireless LAN communication function is enabled.

3. The printing apparatus according to claim 2, wherein in a case where the printing apparatus is not in the supply state and the charge level is less than the first threshold, the printing apparatus transitions to the power state in which the wireless LAN communication function is limited.

4. The printing apparatus according to claim 3, wherein control for transition to the power state is performed in a case where a specific condition is satisfied.

5. The printing apparatus according to claim 4, wherein the specific condition is that a surface with an ejection nozzle of a print head of the printing apparatus is covered with a cap, a backlight of an operation panel of the printing apparatus is disabled, or the power storage unit has the charge level necessary for transition to the power state.

6. The printing apparatus according to claim 4, wherein even in a case where a setting is made to enable the wireless LAN communication function at a time of satisfying the specific condition, if the printing apparatus is not in the supply state and the charge level is less than the first threshold, the printing apparatus transitions to the power state in which the wireless LAN communication function is limited.

7. The printing apparatus according to claim 1, wherein in a case where a power-off operation is detected, the printing apparatus transitions to the power state of a first power-off state, a second power-off state, or a third power-off state based on whether a wireless LAN communication function is enabled.

8. The printing apparatus according to claim 7, wherein the first power-off state is a state that can transition to a power-on state based on receipt of a job from an external device via USB communication or wireless LAN communication, the second power-off state is a state that can transition to the power-on state upon receipt of a job from an external device via the USB communication, and the third power-off state is a state that just accepts a power key operation.

9. The printing apparatus according to claim 8, wherein in a case where the wireless LAN communication function is enabled and the printing apparatus is in the supply state, the printing apparatus transitions to the first power-off state.

10. The printing apparatus according to claim 8, wherein in a case where the wireless LAN communication function is enabled, the printing apparatus is not in the supply state, and the charge level is greater than or equal to a second threshold, the printing apparatus transitions the to the first power-off state.

11. The printing apparatus according to claim 10, wherein even in a case where the wireless LAN communication function is enabled, if the printing apparatus is not in the supply state and the charge level is less than the second threshold, the printing apparatus transitions to the second power-off state.

12. The printing apparatus according to claim 8, wherein in a case where a setting is made to disable the wireless LAN communication function and the printing apparatus is in the supply state, the printing apparatus transitions to the second power-off state.

13. The printing apparatus according to claim 8, wherein in a case where a setting is made to disable the wireless LAN communication function, the printing apparatus is not in the supply state, and the charge level is greater than or equal to a third threshold, the printing apparatus transitions to the second power-off state.

14. The printing apparatus according to claim 13, wherein in a case where a setting is made to disable the wireless LAN communication function, the printing apparatus is not in the supply state, and the charge level is less than the third threshold, the printing apparatus transitions to the third power-off state.

15. A method of controlling a printing apparatus receiving power from a wired interface terminal or power from a power storage unit, the method comprising:
checking a charge level of the power storage unit; and
transitioning to a power state in which a function is limited based on the charge level and whether the printing apparatus is in a supply state in which power is supplied from the wired interface terminal.

16. A non-transitory computer readable storage medium storing a program that functions in a printing apparatus receiving power from a wired interface terminal or power from a power storage unit and causes the printing apparatus to:
check a charge level of the power storage unit; and
transition to a power state in which a function is limited based on the charge level and whether the printing apparatus is in a supply state in which power is supplied from the wired interface terminal.
